(19) United States
(12) Patent Application Publication
(10) Pub. No.: US 2025/0058392 A1
(43) Pub. Date: Feb. 20, 2025

(54) BRAZED HYBRID ALUMINUM/COPPER HEAT EXCHANGERS

(71) Applicant: Dana Canada Corporation, Oakville (CA)

(72) Inventor: Andrei CATUNEANU, Oakville (CA)

(21) Appl. No.: 18/450,313

(22) Filed: Aug. 15, 2023

(51) Int. Cl. B23K 1/00; B23K 1/008; F28D 1/047; F28F 21/08

(52) U.S. Cl. CPC B23K 1/0012; B23K 1/008; F28D 1/0477; F28F 21/084; F28F 21/085

(57) ABSTRACT

A heat exchanger including a first component formed of aluminum and/or aluminum alloy and a second component formed of copper and/or copper alloy. The first element and the second element are fused together by furnace brazing. In some examples, the heat exchanger is an aluminum/copper hybrid heat exchanger including an aluminum and/or aluminum alloy component and a copper and/or copper alloy component. The aluminum and/or aluminum alloy component includes a body and/or cover of the hybrid heat exchanger and the copper and/or copper alloy component includes a heat transfer enhancement component, fixedly coupled to the aluminum and/or aluminum alloy component.

### TECHNICAL FIELD

The present description relates generally to methods and systems for hybrid aluminum/copper heat exchangers.

### BACKGROUND AND SUMMARY

Heat exchangers may be formed of either aluminum/alloys of aluminum (Al) or copper/alloys of copper (Cu). For some applications copper/alloys of copper may be preferred for higher thermal conductivity when compared to the thermal conductivity of aluminum/alloys of aluminum. However, copper/alloys of copper are both heavier and more expensive than aluminum/alloys of aluminum. For applications where cost and/or weight reductions are demanded, such as heat exchangers in vehicles, heat exchangers may be formed of aluminum/alloys of aluminum despite compromising system performance from using a material with a lower thermal conductivity.

Inventors have herein devised a solution to at least partially address the above problem. A heat exchanger body may be formed of aluminum and copper components may be joined to the heat exchanger body in strategic positions to enhance heat transfer. The copper components may also serve a dual purpose as solderable surfaces in applications wherein electronic components are coupled to the heat exchanger. Furnace brazing may be used to join the copper components to the aluminum body. Furnace brazing can be a continuous process and may be efficiently used to mass produce the heat exchangers including both aluminum and copper.

In one example, a heat exchanger is comprised of an aluminum and/or aluminum alloy component including a body and/or a cover, and a copper component and or copper alloy fixedly coupled to the aluminum and or aluminum alloy component, wherein the copper component is a heat transfer enhancement component. The copper component may be fixedly coupled to the aluminum component by controlled atmosphere furnace brazing. In this way, the body and/or cover formed of aluminum may reduce a weight and/or cost of the heat exchanger compared to a heat exchanger formed entirely of copper. The copper components may be placed where an added weight and cost of the copper may provide a higher benefit for the heat transfer efficiency of the heat exchanger than if the same weight of copper had formed a component or portion of the heat exchanger which is not the fin and/or turbulizer. Further, furnace brazing may be a scalable and cost effective method for fixedly coupling the aluminum and copper components of the heat exchanger. Furnace brazing may include controlled atmosphere brazing and vacuum brazing.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1A shows a side view of an example of a single sided Al/Cu hybrid heat exchanger.

FIG. 1B shows a top sectional view of the single sided Al/Cu hybrid heat exchanger.

FIG. 1C shows a first alternate embodiment of the top sectional view of the single sided Al/Cu heat exchanger.

FIG. 2 shows a side view of an example of a dual assembly Al/Cu hybrid heat exchanger.

FIG. 3 shows a side view of a double sided Al/Cu hybrid heat exchanger.

FIG. 4 shows a side view of an example of a gas-liquid Al/Cu hybrid heat exchanger.

FIG. 5 shows a side of an example of liquid Al/Cu hybrid heat exchanger including stacked heat transfer channels.

FIG. 6A shows a side view of an example of a single sided Al/Cu hybrid heat exchanger including multiple channels.

FIG. 6B shows a top sectional view of the example of the single sided Al/Cu hybrid heat exchanger of FIG. 6A.

FIG. 7 shows top sectional view of an example of a single sided Al/Cu hybrid heat exchanger including multiple passes.

FIG. 8A shows a top sectional view of a first alternate embodiment of the single sided Al/Cu hybrid heat exchanger of FIGS. 1A-1C.

FIG. 8B shows a top sectional view of a second alternate embodiment of the single sided Al/Cu hybrid heat exchanger of FIGS. 1A-1C.

FIG. 9A shows an example of a single sided Al/Cu hybrid heat exchanger including a bi-metal cover component.

FIG. 9B shows a first alternate embodiment of the bi-metal cover of FIG. 9A.

FIG. 9C shows a second alternate embodiment of the bi-metal cover of FIG. 9A.

FIG. 10 shows an example of a single sided Al/Cu hybrid heat exchanger including a bi-metallic body.

FIG. 11 shows an example of a gas-liquid Al/Cu hybrid heat exchanger including a bi-metallic body.

FIG. 12 shows an example of liquid-liquid Al/Cu hybrid heat exchanger including stacked heat transfer channels and a bi-metallic body.

FIG. 13A shows a side view of a third embodiment of a single sided Al/Cu hybrid heat exchanger including a copper (Cu) portion.

FIG. 13B shows a side view of a fourth embodiment of the single sided Al/Cu hybrid heat exchanger including a Cu portion.

FIG. 13C shows a first alternate example of a top view of the single sided Al/Cu hybrid heat exchanger of FIGS. 13A-13B.

FIG. 13D shows a second alternate example of a top view of the single sided Al/Cu hybrid heat exchanger of FIGS. 13A-13B.

FIG. 14 shows an example of a tube-fin Al/Cu hybrid heat exchanger.

FIG. 15 shows an example of concentric tube Al/Cu hybrid heat exchanger.

### DETAILED DESCRIPTION

The following disclosure relates to aluminum/copper (Al/Cu) hybrid heat exchangers. The aluminum/copper hybrid heat exchanger may include a combination of a first component formed of aluminum or aluminum alloy (e.g., aluminum or aluminum alloy component) and a second component formed of copper or copper alloy (e.g., copper or copper alloy component). The aluminum component may include a body and/or a cover of the heat exchanger to reduce both a cost and weight of the heat exchanger compared to a body and/or a cover formed of copper. One or more heat transfer enhancement components or other components including surface area in direct contact with a coolant, such as turbulizers (e.g., turbulators) or fins may be formed of copper. As another example, heat transfer enhancement components, such as dimples or ribs, may be formed into a body of the Al/Cu hybrid heat exchanger. Herein, where components are referred to as formed of aluminum it is understood that they may also be formed of an aluminum alloy and where components are referred to as formed of copper it is understood that they may also be formed of a copper alloy. Herein, a copper alloy may include copper and one or more other metals and/or metalloids, with copper being included at the highest weight %. Further an aluminum alloy may include one or more other metals or metalloids and/or metalloids, with aluminum being included at the highest weight %. A volume and quantity of copper components may be selected based on a desired weight and cost of the Al/Cu hybrid heat exchanger in addition to a desired heat transfer efficiency of Al/Cu hybrid heat exchanger. The heat transfer efficiency of the Al/Cu hybrid heat exchanger may be greater than that of a heat exchanger of an equivalent design which is formed solely of aluminum. The aluminum and copper components of the Al/Cu hybrid heat exchanger may be furnace brazed together to form the Al/Cu hybrid heat exchanger. For this reason, the aluminum and copper components of the Al/Cu hybrid heat exchanger may be configured to be joined by furnace braze process. Herein, furnace brazing refers to controlled atmosphere brazing and/or vacuum brazing. Furnace brazing may be a preferred method for joining components of the Al/Cu hybrid heat exchanger because it is a well-controlled, continuous or batch, high throughput process.

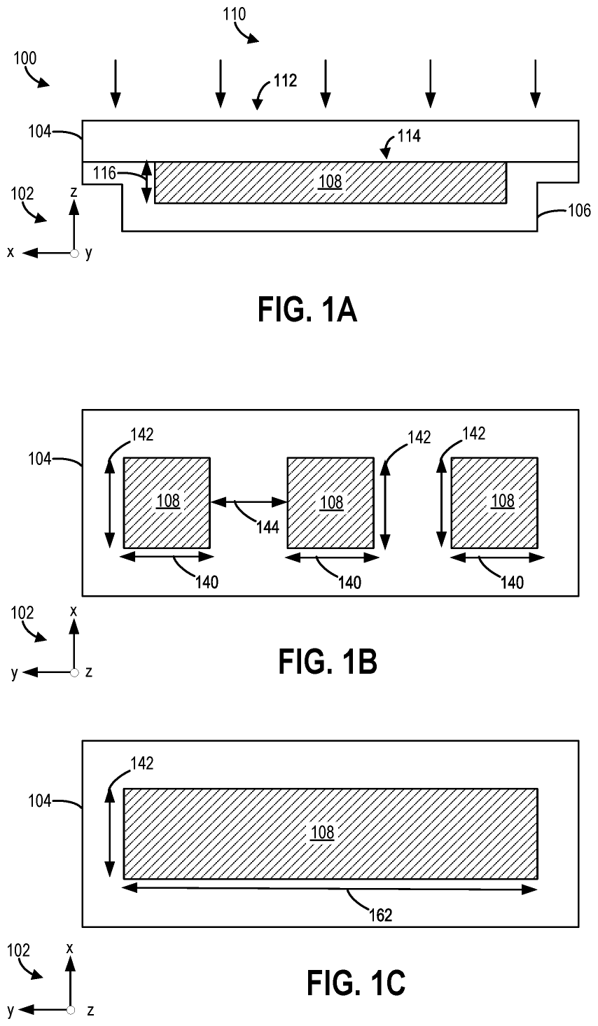

The Al/Cu hybrid heat exchanger may be included in a system in which heat transfer efficiency of an all-aluminum heat exchanger is not sufficient but an all-copper heat exchanger is too heavy and/or expensive. As one example, the Al/Cu hybrid heat exchanger may be used as a heat exchanger of a vehicle. FIGS. 1A-15, detailed further below, show non-limiting examples of embodiments of Al/Cu hybrid heat exchangers. The heat exchangers 1A-15 may further include inlets and outlets to facilitate flow of liquids and gases into and out of the heat exchangers as appropriate. The inlets and outlets have been omitted from the views in FIGS. 1A-15 for clarity.

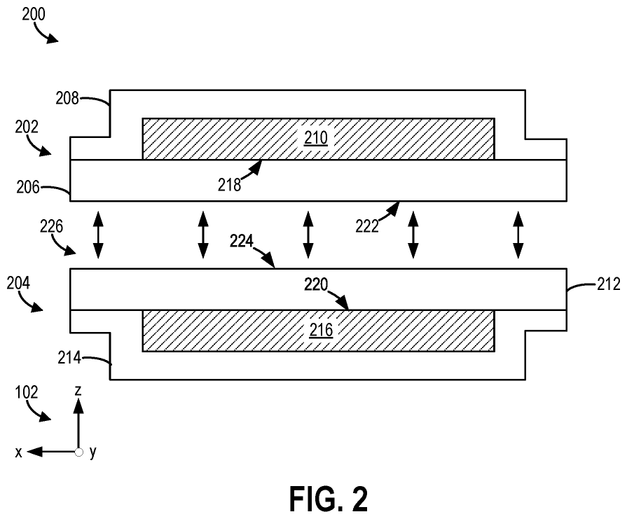

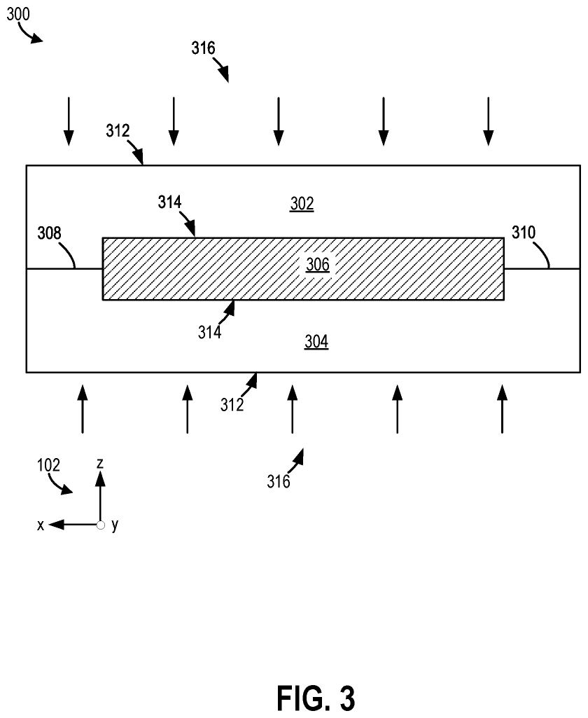

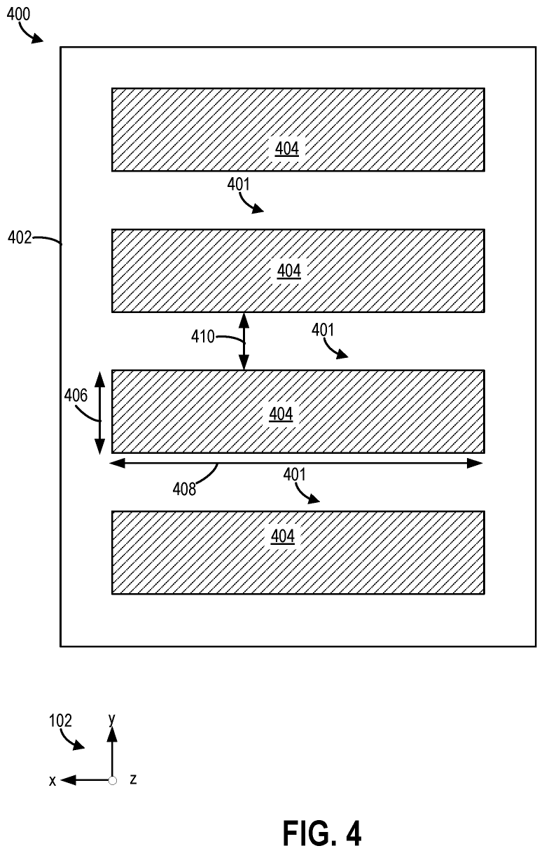

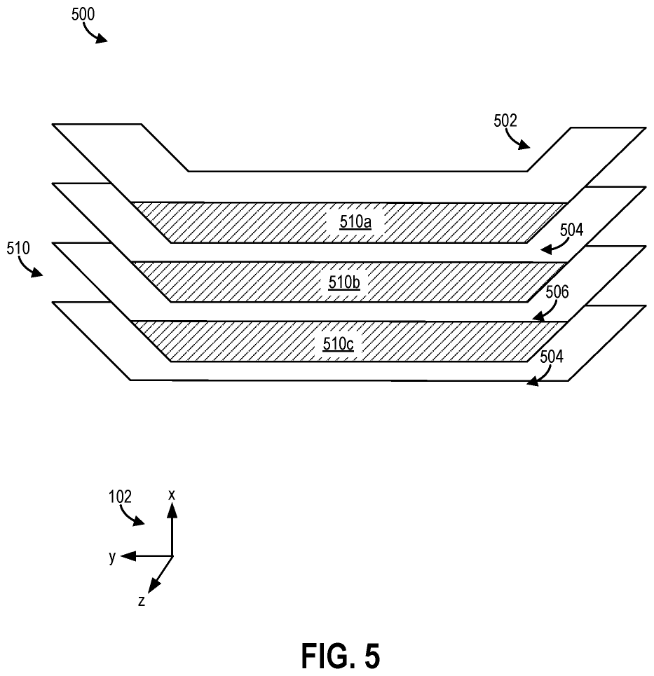

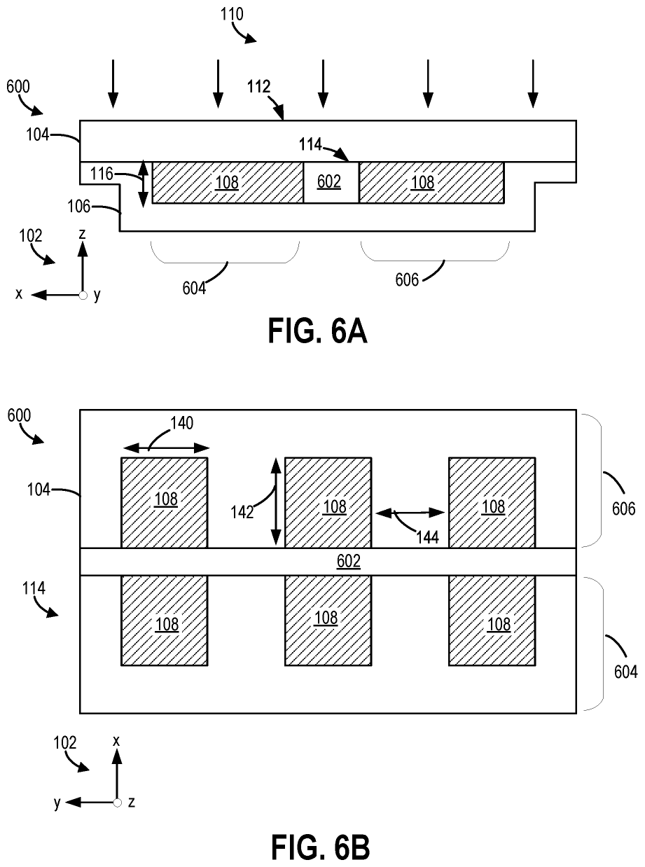

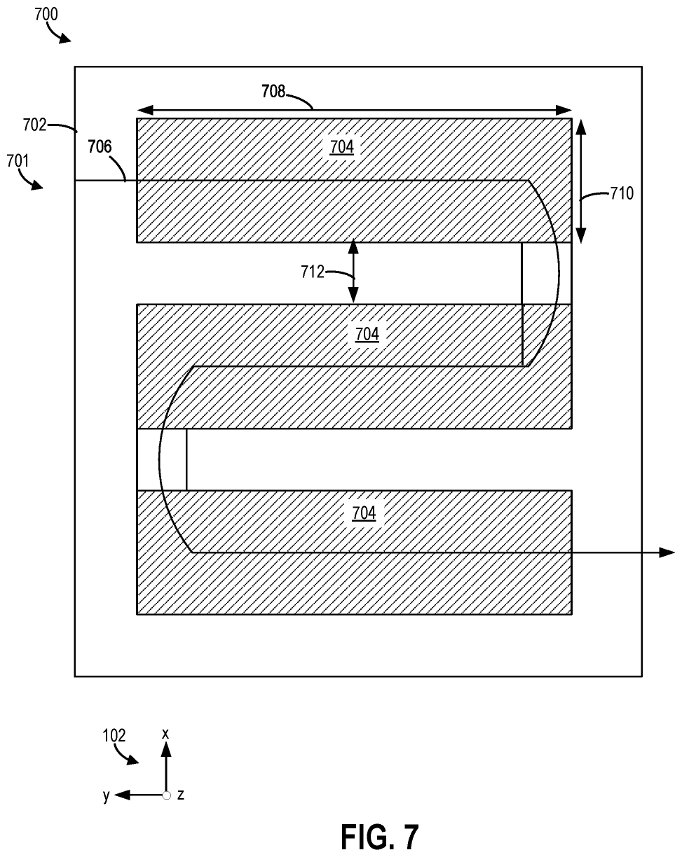

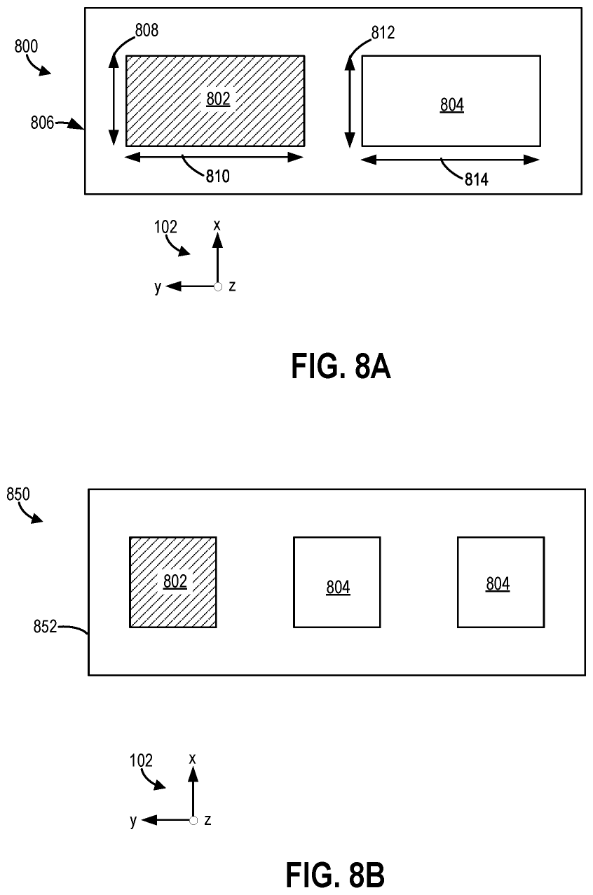

In one example, the Al/Cu hybrid heat exchanger may be a single sided Al/Cu hybrid heat exchanger as shown in FIGS. 1A-1C. Additionally or alternatively, the Al/Cu hybrid heat exchanger may be a dual assembly Al/Cu hybrid heat exchanger as shown in FIG. 2 configured to cool two sides of a heat generating object or a double sided Al/Cu hybrid heat exchanger as shown in FIG. 3 configured to provide cooling at two different sides. Further, the Al/Cu hybrid heat exchanger may be a gas-liquid Al/Cu hybrid heat exchanger as shown in FIG. 4. As another example, the Al/Cu hybrid heat exchanger may be a liquid multi-channel Al/Cu hybrid heat exchanger as shown in FIG. 5. Additional examples of a single sided Al/Cu hybrid heat exchanger are shown in FIGS. 6-7 including multi-channel or serpentine channel variations. In further embodiments, an Al/Cu hybrid heat exchanger may include a plurality of heat transfer enhancement components (e.g., fins and/or turbulizers) and a first fin and/or turbulizer may be formed of aluminum while a second fin and/or turbulizer is formed of copper. A non-limiting example of both aluminum and copper protrusions is shown in FIGS. 8A-8B.

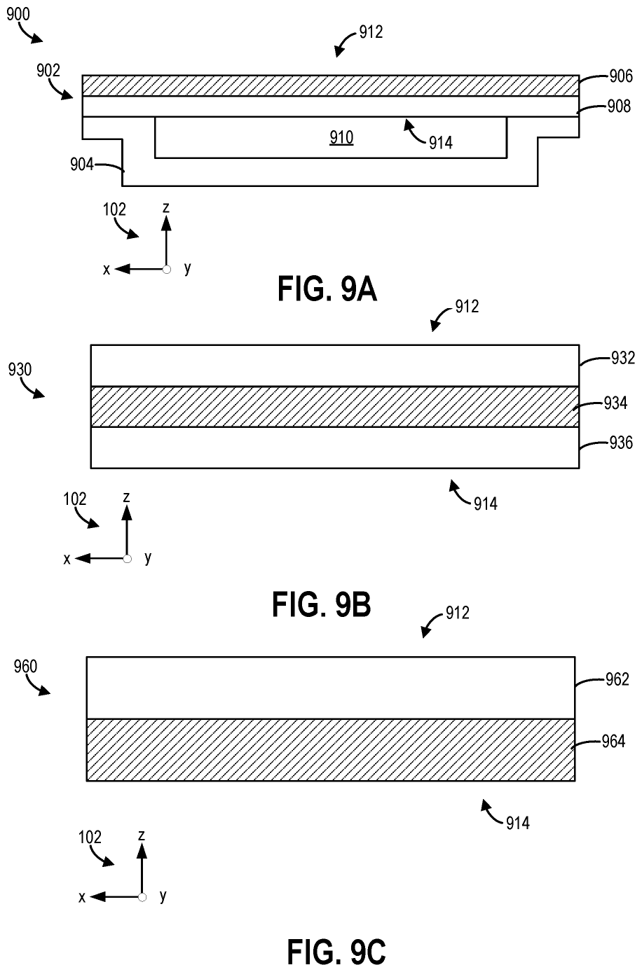

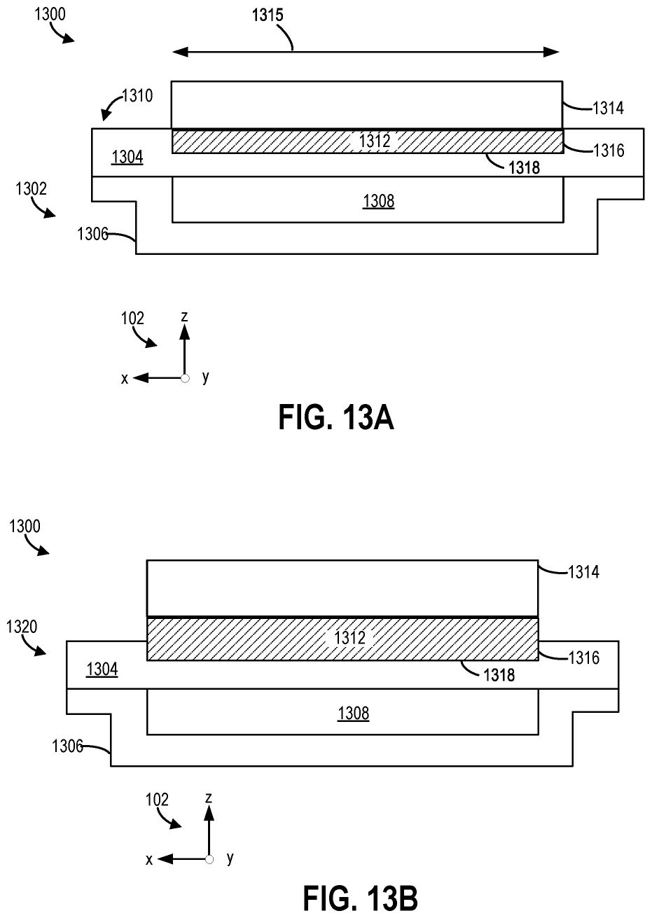

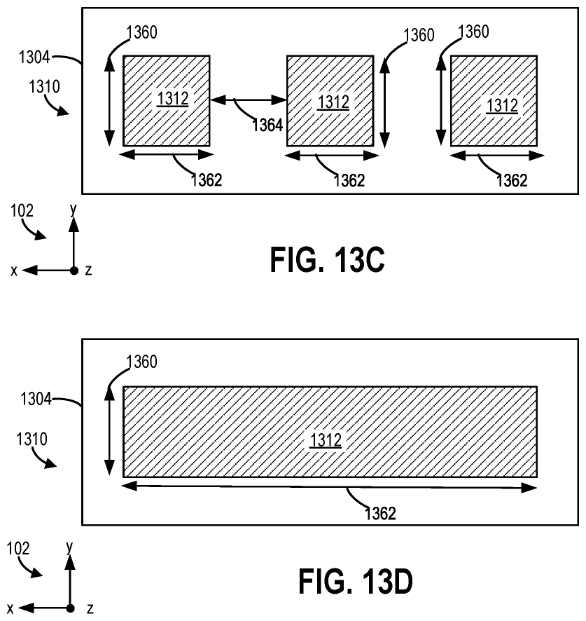

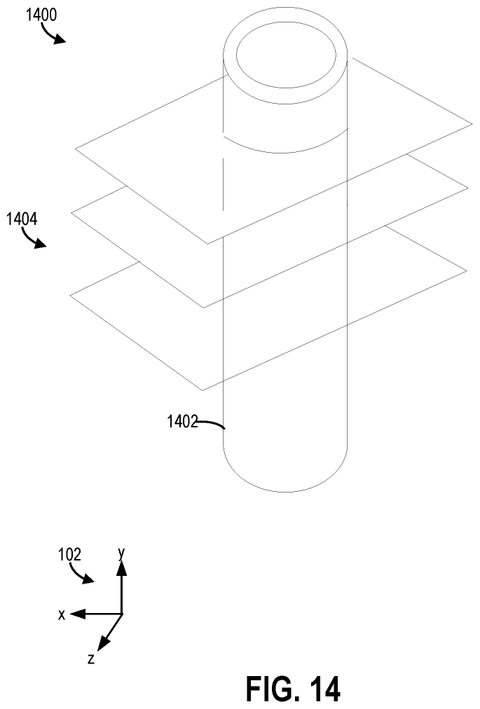

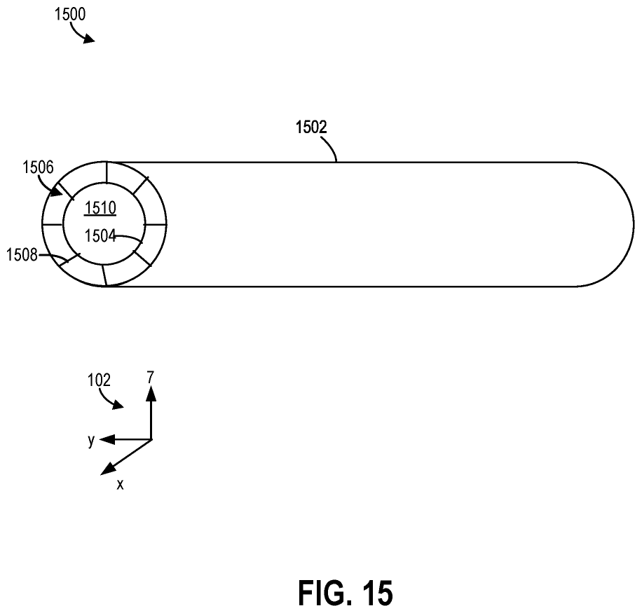

A body of the Al/Cu hybrid heat exchanger may, additionally or alternatively, be formed of bimetallic (e.g., copper and aluminum) and/or multiple alternating layers of aluminum and copper. Non-limiting examples of the single sided, gas-liquid, and liquid multi-channel Al/Cu hybrid heat exchangers including bimetallic or multi-layered bodies are shown in FIGS. 9A-12. In still further examples, the copper components of the Al/Cu hybrid heat exchanger may be strategically placed at an outer surface of the Al/Cu hybrid heat exchanger and configured to be conductively coupled to electronic components as shown in FIGS. 9A and 13A-13D. Additional examples Al/Cu hybrid heat exchangers include tube-fin heat exchangers and concentric heat exchangers as illustrated in FIGS. 14 and 15 respectively.

Turning now to FIG. 1A, a side view of an example of a single sided Al/Cu hybrid heat exchanger 100 is shown. A coordinate axis 102 including an x-axis, a y-axis, and a z-axis is provided for reference between FIGS. 1A-15. The y-axis may be a longitudinal axis, the x-axis may be a lateral axis (e.g., horizontal axis), and the z-axis may be a vertical axis along which height is measured, in one example. However, the axes may have other orientations, in other examples.

Single sided Al/Cu hybrid heat exchanger 100 may include a body 106 and a cover 104. Body 106 may include a trench traveling along the y-axis. Body 106 is coupled to cover 104 and forms a leak tight passage through which liquid coolant may be flowed in a direction along the y-axis. Said another way, three sides of the water tight passage may be formed by a trench along the y-axis through body 106 and a fourth side of the water tight passage is formed by a cold side 114 of cover 104. A side of cover 104 coupled to body 106 may be referred to as the inner side or as cold side 114. An outer side of cover 104 may be referred to as a hot side 112. In one example, the hot side may be a temperature which is higher than a temperature of the cold side. Single sided Al/Cu hybrid heat exchanger 100 may be positioned such that heat from a heat generating component may radiate towards a hot side 112 of cover 104 as shown by arrows 110. The heat from a heat generating component may first reach hot side 112 before being thermally conducted to cold side 114. In some examples, the heat generating component may be directly physically coupled to hot side 112. Liquid coolant may flow through the water tight passage and cool the cold side 114 of cover 104. Cold side 114 may be parallel to and opposite hot side 112 across the z-axis. Both body 106 and cover 104 may be formed of aluminum. In alternate embodiments, body 106 may be formed of copper and cover 104 may be formed of aluminum. In alternate embodiments, body 106 may be formed of aluminum and cover 104 may be formed of copper.

A turbulizer (e.g., turbulator) 108 may be in face sharing contact with cold side 114 of cover 104. Additionally or alternatively, turbulizer 108 may be in face sharing contact with an interior surface of body 106. Turbulizer 108 may extend a height 116 along the z-axis into the water tight passage through which the liquid coolant flows. Turbulizer 108 may be formed of copper and may be fixedly coupled to cold side 114 of cover 104 by furnace brazing. Turbulizer 108 may be in direct contact with the liquid coolant to cause turbulent flow of the liquid coolant around the turbulizer and thereby providing a greater surface area for heat transfer from cold side 114. Additionally or alternatively, turbulizer 108 may be strategically positioned to be directly opposite a portion of hot side 112 subjected to a highest heat load from the heat generating component. In this way, a strategic component (e.g., the turbulizer) of single sided Al/Cu hybrid heat exchanger 100 may be formed of copper while a remainder is formed of aluminum and an overall material cost and weight of single sided Al/Cu hybrid heat exchanger 100 may be reduced relative to a matching heat exchanger formed entirely of copper while a heat transfer efficiency of the single sided liquid Al/Cu hybrid heat exchanger may be enhanced relative to a matching heat exchanger formed entirely of aluminum.

Dimensions, quantities, and spacing of turbulizer 108 may selected based on a maximum threshold cost and weight of the single sided Al/Cu hybrid heat exchanger, characteristics of the heat load, desired heat transfer efficiency, and a desired turbulent flow and pressure drop. A first embodiment of turbulizer 108 is shown in FIG. 1B, as a top sectional view looking through cover 104 along the z-axis. The single sided Al/Cu hybrid heat exchanger may include multiple independent iterations of turbulizer 108. Turbulizer 108 may be a length 140 measured along the y-axis and a width 142 measured along the x-axis. Each turbulizer 108 may be spaced a distance 144 from a neighboring turbulizer 108. A second embodiment of turbulizer 108 is shown as a top sectional view in FIG. 1C. According to the second embodiment, turbulizer 108 may be a width 142 and a length 162. Length 162 may be longer than length 140. Cover 104 including the first embodiment of turbulizer 108 may include less copper and may be less expensive and lighter than cover 104 including the second embodiment of turbulizer 108. In alternate examples, dimensions, quantities, and spacing of turbulizers may be chosen to serve as structural support of the cover 104 or based on minimizing manufacturing complexity. In some embodiments, dimensions of turbulizer 108 may depend on dimensions of the heat generating component coupled to hot side 112 of cover 104. In examples where the single sided Al/Cu hybrid heat exchanger includes more than one turbulizer, dimensions of each turbulizer and spacing between the turbulizer may be varied throughout the single sided Al/Cu hybrid heat exchanger.

Turning now to FIG. 2 a side view of an example of a dual assembly Al/Cu hybrid heat exchanger 200 is shown. Dual assembly Al/Cu hybrid heat exchanger 200 may include a first cooling member 202 and a second cooling member 204. First cooling member 202 may include a first cover 206, a first body 208, and a first turbulizer 210. Second cooling member 204 may include a second cover 212, a second body 214, and a second turbulizer 216. First cooling member 202 and second cooling member 204 may each be configured as a single sided liquid Al/Cu hybrid heat exchanger as described above with respect to FIGS. 1A-1C with liquid coolant flowing through first cooling member 202 and second cooling member 204 along the y-axis. First body 208, second body 214, first cover 206, and second cover 212 may each be formed from aluminum.

First cover 206 and second cover 212 may include a first cold side 218 and a second cold side 220 respectively in addition to a first hot side 222 and a second hot side 224 respectively. First hot side 222 may be parallel to and positioned opposite second hot side 224 across the z-axis. Heat, as represented by double sided arrows 226, may be generated between first cooling member 202 and second cooling member 204 and may radiate towards both first hot side 222 and second hot side 224. For example, a heat generating component may be positioned between the first cover 206 and the second cover 212 and may emit heat which radiates towards both the first hot side 222 and second hot side 224.

First turbulizer 210 may be in face sharing contact with first cold side 218 and second turbulizer 216 may be in face sharing contact with second cold side 220. Additionally or alternatively, first turbulizer 210 and/or second turbulizer 216 may be in face sharing contact with an interior surface of body first body 208 and second body 214, respectively. First turbulizer and second turbulizer may be configured similarly as an embodiment of turbulizer 108 of FIGS. 1A-1C and may each be formed of copper fixedly coupled to the respective aluminum cover by furnace brazing. In some embodiments, dimensions (e.g., height, width, and depth, similar to width 142, length 140, and height 116 respectively) of first turbulizer 210 may be the same as dimensions of second turbulizer 216. In alternate embodiments the dimensions of first turbulizer 210 may be different from the dimensions of second turbulizer 216. As one example, if the heat generating component between first cooling member 202 and second cooling member 204 is hotter on a side closer to first cooling member 202, then larger dimensions of first turbulizer 210 and smaller dimensions of second turbulizer 216 may be desired. In this way, dimensions and form of dual assembly Al/Cu hybrid heat exchanger 200 may also be adjusted to a maximum threshold weight percent of copper based on desired weight, cost, pressured drop, and heat transport of dual assembly Al/Cu hybrid heat exchanger 200.

Turning now to FIG. 3, a side view of a double sided Al/Cu hybrid heat exchanger 300 is shown. The double sided Al/Cu hybrid heat exchanger 300 may include a first body 302 and a second body 304. Both first body 302 and second body 304 may be formed of aluminum and shaped similarly to body 106 of FIG. 1A. First body 302 may be fixedly coupled to second body 304 at first joint 308 and second joint 310 forming a passage along the y-axis through which liquid coolant may flow.

Double sided Al/Cu hybrid heat exchanger 300 includes a hot side 312 and a cold side 314. Hot side 312 may be comprised of outer sides of first body 302 and second body 304, and may be exposed to heat as represented by plurality of arrows 316. Cold side 314 may be comprised of inner sides of first body 302 and second body 304. A turbulizer 306 may be coupled to cold side 314. Turbulizer 306 may be formed of copper and may be coupled to cold side 314 by furnace brazing. Dimensions, quantities, and spacing of turbulizer 306 may be chosen according to a desired cost, weight, and heat transfer efficiency of double sided Al/Cu hybrid heat exchanger 300 as described above with respect to FIGS. 1A-1C.

Turning now to FIG. 4, a side sectional view of a portion of a gas-liquid Al/Cu hybrid heat exchanger 400 is shown. In some examples, gas-liquid Al/Cu hybrid heat exchanger 400 may be a radiator, such as a radiator of a vehicle. A body 402 of gas-liquid Al/Cu hybrid heat exchanger 400 of may be formed of aluminum. Body 402 may include a plurality of passages 401 configured to allow hot liquid to flow along the z-axis between a plurality of fins 404. The plurality of fins 404 may be formed of copper and may be joined to the aluminum body by furnace brazing. The plurality of fins 404 may be a height 406, a width 408 and may extend a distance along the z-axis. Each of the plurality of fins 404 may be spaced a distance 410 from each other.

Heat from the hot liquid may be transferred from the plurality of passages 401 to the plurality of fins 404. The plurality of fins 404 may be in direct contact with and therefore cooled by cold gas (e.g., air) forced across the plurality of fins 404 in the x-direction and in fluid contact with the plurality of fins 404. In some examples, one or more turbulators may be positioned within the plurality of passages 401. The one or more turbulators may be formed of copper and may be fixedly coupled to the plurality of passages 401 by furnace brazing. Dimensions (e.g., height 406, width 408, fin length along the z-axis) and the distance 410 may each be chosen to determine a weight of copper to be included in the gas-liquid Al/Cu hybrid heat exchanger 400. Increasing height 406, width 408, the distance along the z-axis and/or decreasing distance 410 may increase a heat transfer efficiency of the gas-liquid Al/Cu hybrid heat exchanger 400 but may increase a weight and cost of gas-liquid Al/Cu hybrid heat exchanger 400. The weight and cost may be balanced with a demanded heat transfer efficiency according to an application of the gas-liquid Al/Cu hybrid heat exchanger 400.

Turning now to FIG. 5, a section of a multi-channel liquid-liquid Al/Cu hybrid heat exchanger 500 is shown. Multi-channel liquid-liquid Al/Cu hybrid heat exchanger 500 may be formed of a plurality of plates (e.g., a plurality of bodies) 502 arranged in a parallel fashion along the x-axis and spaced apart. Multi-channel liquid-liquid Al/Cu hybrid heat exchanger may further include a plurality of fins 510. The plurality of fins 510 may include a first fin 510a, and second fin 510b, and third fin 510c. Each of plurality of fins 510 may be coupled to an edge of one of the plurality of plates 502. Each of the plurality of fins 510 may be fixedly coupled by furnace brazing to a corresponding edge of the plurality of plates 502. In this way, each fin of plurality of fins 510 may be stacked in a parallel fashion along the x-axis, similar to the plurality of plates 502. Each of the plurality of plates 502 may be formed of aluminum and each of the plurality of fins 510 may be formed of copper.

First fin 510a may be positioned first liquid channel 504 and second fin 510b may be positioned within a second liquid channel 506. A first liquid at a first temperature may flow through first liquid channel 504 and a second liquid at a second temperature may flow through second liquid channel 506. First liquid channel 504 and second liquid channel 506 stack in an alternating fashion along the x-axis. The first liquid channel 504 may be physically separated from second liquid channel 506 so that heat may be transferred between the first liquid and the second liquid without the first liquid and the second liquid physically mixing. A size and shape of each of the plurality of fins may be selected based on a demanded heat transfer efficiency and cost/weight specifications of multi-channel liquid-liquid Al/Cu hybrid heat exchanger 500.

Turning now to FIG. 6A-6B a multi-channel single sided Al/Cu hybrid heat exchanger 600 is shown. FIG. 6A shows a side view while FIG. 6B shows a top sectional view. Multi-channel single sided Al/Cu hybrid heat exchanger 600 may be similar to single sided Al/Cu hybrid heat exchanger 100 described above with respect to FIGS. 1A-1C, components may be labeled similarly and will not be reintroduced. Multi-channel single sided Al/Cu hybrid heat exchanger 600 may include a wall 602 extending perpendicularly from cold side 114 of cover 104 to meet an inner surface of body 106. Wall 602 may be formed of aluminum, similar to cover 104 and body 106. Wall 602 may delineate a first coolant channel as indicated by bracket 604 and a second coolant channel as indicated by bracket 606. Liquid coolant may flow through each of the first coolant channel and the second coolant channel. Further, both of the first channel and the second channel may include turbulizer 108. In some examples, multi-channel single sided Al/Cu hybrid heat exchanger 600 may include more than one wall 602 and multiple coolant channels (e.g., more than two coolant channels).

As shown in the top view of FIG. 6B, each of the first channel and the second channel may include a turbulizer 108. Dimensions of turbulizer 108 may be given by width 142, length 140, and height 116 as described previously with respect to FIGS. 1B-1C. Turbulizer 108 of the first channel may be the same or different dimensions as turbulizer 108 of the second channel. As one example, the first channel may experience a higher heat load than the second channel, and turbulizer 108 of the first channel may be larger dimensions and/or spaced closer together than turbulizer 108 of the second channel. In this way, a wt. % of copper of the multi-channel single sided Al/Cu hybrid heat exchanger 600 may be adjusted based on a demand of the heat transfer efficiency of the heat exchanger and the copper that is included is in an optimized position according to a heat load of the heat exchanger.

FIG. 7 shows a top sectional view of a serpentine single sided Al/Cu hybrid heat exchanger 700. The top sectional view may show a cold side 701 of a cover 702 of single sided liquid Al/Cu hybrid heat exchanger. Similar to single sided Al/Cu hybrid heat exchanger 100. cover 702 may be formed of aluminum and may be coupled to a body formed of aluminum of the serpentine single sided Al/Cu hybrid heat exchanger 700, thereby enclosing a passage through which liquid coolant may flow. Turbulizer 704 may be similar to turbulizer 108 and may be formed of copper and fixedly coupled to cover 702 and/or a body of the serpentine single sided Al/Cu hybrid heat exchanger 700 by furnace brazing. Arrow 706 corresponds to a serpentine path of the liquid coolant flow through a serpentine coolant channel and past turbulizer 704. The serpentine coolant channel may be defined by walls of the serpentine single sided Al/Cu hybrid heat exchanger 700 which may be formed of aluminum and may extend perpendicularly from cover 704 to the base as described above with respect to wall 602 of FIG. 6A-6B.

Dimensions for turbulizer 704 may include length 708, width 710 and a height extending perpendicular to cover 704 along the z-axis. Turbulizer 704 may also be iterated multiple times and each iteration may be separated by a distance 712. As described above with respect to FIGS. 1A-1C and 6A-6B, dimensions may be selected to balance a heat transfer and pressure drop demand for more copper with a weight and/or cost demand for more aluminum. In some examples turbulizer 704 may not be equivalent in dimension and spacing throughout serpentine single sided Al/Cu hybrid heat exchanger 700. As one example turbulizer 704 may have larger dimensions and be spaced closer together in positions corresponding to greater heat generated by the component be cooled. As an alternate example, turbulizer 704 may have larger dimensions and be spaced closer together near an outlet of liquid coolant passage, where the temperature difference between the coolant and the component to be cooled by be less than the temperature difference near an inlet of the liquid coolant passage.

In examples of Al/Cu hybrid heat exchangers which include a plurality of turbulizers and/or fins, the plurality of turbulizers and/or fins may include both copper turbulizers/fins and aluminum turbulizers/fins. Both aluminum and copper turbulizers and/or fins may be coupled to a body and/or cover of the Al/Cu hybrid heat exchanger by furnace brazing in a single step. During design and manufacturing of the Al/Cu hybrid heat exchanger, selecting a number and dimensions of both aluminum fins/turbulizers and copper fins/turbulizers may be used for heat transfer balancing of the Al/Cu hybrid heat exchanger. Additionally or alternatively selecting the number and dimensions of aluminum fins/turbulizers and copper fins/turbulizers may be part of value engineering process in commencing to design a heat exchanger product or part of a value added process in modifying existing heat exchangers. Non limiting examples including both aluminum turbulizers and copper turbulizers are described further below with respect to FIG. 8A-B.

Turning now to FIG. 8A-B, a top sectional view of a first alternate single sided Al/Cu hybrid heat exchanger is shown in FIG. 8A and a top sectional view of a second alternative single sided Al/Cu hybrid heat exchanger is shown in FIG. 8B. Both first alternate 800 and second alternate 850 may be similar to single sided Al/Cu hybrid heat exchangers discussed above with respect to FIGS. 1A-C, and 6-7. Additionally, any of the fins and/or turbulizers described above with respect to any of FIGS. 1-7 may be formed of at least one copper turbulizer/fin and the remaining turbulizers/fins may be formed of aluminum.

First alternate 800, shown in FIG. 8A, may include a copper turbulizer 802 and an aluminum turbulizer 804 each fixedly coupled to a cold side 806 of a cover of the first alternate 800. Additionally or alternatively, aluminum turbulizer 804 and/or copper turbulizer 802 may be fixedly coupled to an interior surface of a body of first alternate 800. Dimensions of copper turbulizer 802 including width 808, length 810, and a height along the z-axis and dimensions of aluminum turbulizer 804 including width 812, length 814 and a height along the z-axis may be equivalent or different. In one example, copper turbulizer 802 may be closest to a position under a higher heat load and demanding increased heat transfer efficiency while aluminum turbulizer 804 may be positioned in a position under a lower heat load and demanding decreased heat transfer efficiency compared to the position of copper turbulizer 802.

Second alternate 850, shown in FIG. 8B, may include a copper turbulizer 802 and a plurality of aluminum turbulizers 804, each fixedly coupled to the cold side 852 of the second. Additionally or alternatively, aluminum turbulizer 804 and/or copper turbulizer 802 may be fixedly coupled to an interior surface of the body of second alternate 850. As described above with respect to FIG. 8A, dimensions of copper turbulizer 802 and aluminum turbulizer 804 may be equivalent or different.

Additionally or alternatively to examples of Al/Cu hybrid heat exchangers discussed above with respect to FIGS. 1A-8B, components described as formed of aluminum (e.g., a body or cover the Al/Cu hybrid heat exchanger) may be formed of a combination of aluminum and copper. In examples discussed below, aluminum and copper may be layered followed by furnace brazing to from a body and/or cover which is between 0 wt. % and 100 wt. % copper and a remainder formed of aluminum. Further, the component copper layer may be a copper alloy and the aluminum layer may be an aluminum alloy. By selecting a wt. % of copper in the body and/or cover components of the Al/Cu hybrid heat exchanger a weight/cost may be balanced with a heat transfer performance of the heat exchanger according to a system in which the Al/Cu hybrid heat exchanger is included.

Turning now to FIG. 9A, a side view of a first example of a multi-layer single sided Al/Cu hybrid heat exchanger 900 is shown. First example 900 may be similar to single sided Al/Cu hybrid heat exchanger 100 described above with respect to FIG. 1A-1C. Additionally or alternatively, first example 900 may be a dual assembly, double sided, and/or include multiple or serpentine channels similar the examples of single sided liquid Al/Cu hybrid heat exchangers shown in FIGS. 2-3 and 6A-7. First example 900 may include a body 904 coupled to a cover 902 thereby defining a passage 910 through which liquid coolant may flow. Cover 902 may include a cold side 914 and a hot side 912. Hot side 912 may be coupled to a heat generating component being cooled by first example 900. A portion of cold side 914 may be in face sharing contact with the liquid coolant. In some embodiments, first example 900 may also include turbulizers as described above with respect to FIGS. 1A-3, and 6-8.

Cover 902 may include an aluminum layer 908 and a copper layer 906. Aluminum layer 908 may comprise cold side 914 and may be in face sharing contact with body 904. Further, aluminum layer 908 may partially define passage 910. A side of aluminum layer 908 closest to hot side 912 may be in face sharing contact with a copper layer 906. Copper layer 906 may comprise a hot side 912 of cover 902. Copper layer 906 may be fixedly coupled to aluminum layer 908 by furnace brazing. Thickness of copper layer 906 and aluminum layer 908 along the z-axis may be selected based on a desired wt. % of copper and aluminum for cover 902.

Turning now to FIG. 9B, a side view of a first alternate embodiment 930 of a cover of multi-layered liquid Al/Cu hybrid heat exchanger 900 is shown. First alternate embodiment 930 may include a first aluminum layer 932, a copper layer 934, and a second aluminum layer 936. First aluminum layer 932 may comprise the hot side 912 and second aluminum layer 936 may comprise cold side 914. Copper layer 934 may be sandwiched between first aluminum layer 932 and second aluminum layer 936. A side of copper layer 934 closest to hot side 912 may be in face sharing contact and fixedly coupled to first aluminum layer 932 by furnace brazing. Likewise, a side of copper layer 934 closest to cold side 914 may be in face sharing contact and fixedly coupled to second aluminum layer 936 by furnace brazing.

Turning now to FIG. 9C, a side view of a second embodiment 960 of a cover of multi-layered liquid Al/Cu hybrid heat exchanger 900 is shown. Second embodiment 960 may be similar to cover 902, except for positons of the copper layer and aluminum layer are swapped. The second embodiment 960 may include an aluminum layer 962 comprising 912 and a copper layer 964 comprising a cold side 914. In an additional embodiment, cover 930 may include an aluminum layer sandwiched between a first and second copper layer. Embodiments such as 902 may be selected for applications such as cooling power electronics, where a hot side 912 comprising the copper layer allows for direct electrical coupling of the power electronic to the Al/Cu hybrid heat exchanger.

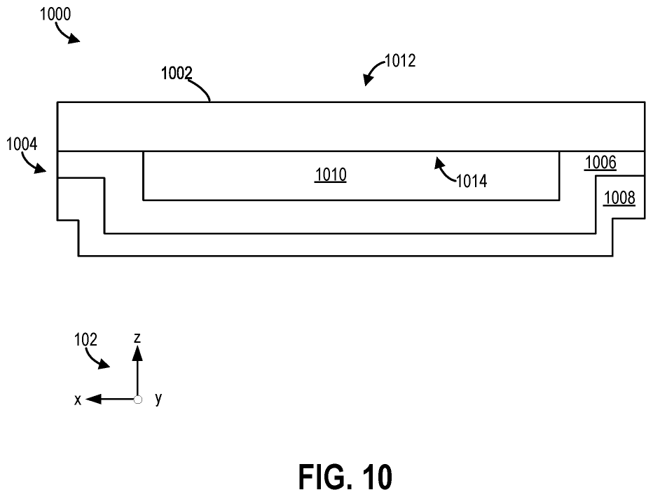

Turning now to FIG. 10, a side view of a second example of a multi-layer single sided liquid Al/Cu hybrid heat exchanger 1000 is shown. Second example 1000 may be similar to single sided Al/Cu hybrid heat exchanger 100 described above with respect to FIG. 1A-1C. Additionally or alternatively, second example 1000 may include multiple or serpentine channels similar the examples of single sided liquid Al/Cu hybrid heat exchangers shown in FIGS. 6A-7 or may be a dual assembly or double sided as shown in FIGS. 2-3, respectively. Second example 1000 may include a body 1004 coupled to a cover 1002 thereby defining a passage 1010 through which liquid coolant may flow. Cover 1002 may be similar to cover 104 of FIG. 1A and may include a cold side 1014 and a hot side 1012. Second example 1000 may also include turbulizers fixedly coupled to cover 1002, positioned along the y-axis as described above with respect to FIGS. 1A-3 and 6-8B. Additionally or alternatively, second example 1000 may also include a multi-layered cover as described above with respect to FIGS. 9A-9C.

Body 1004 may include a first layer 1006 and a second layer 1008. First layer 1006 may be coupled to cover 1002 and may, along with cover 1002 define passage 1010. First layer 1006 may form a side of body 1004 closest to cover 1002. A side of first layer 1006 furthest from cover 1002 may be in face sharing contact with second layer 1008. First layer 1006 may completely cover a face of second layer 1008. First layer 1006 may be fixedly coupled to second layer 1008 by furnace brazing.

In some embodiments first layer 1006 may be formed of aluminum or aluminum alloys and second layer 1008 may be formed of copper or copper alloys. In alternate embodiments first layer 1006 may be formed of copper or copper alloys and second layer 1008 may be formed of aluminum or aluminum alloys.

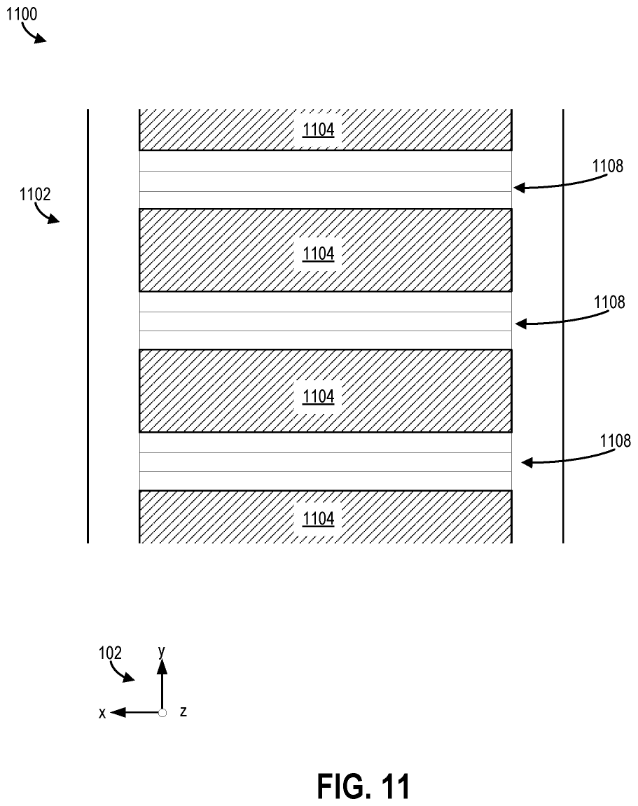

Turning now to FIG. 11, an example of a multi-layered gas-liquid Al/Cu hybrid heat exchanger 1100 is shown. Multi-layered gas-liquid Al/Cu hybrid heat exchanger 1100 may be similar to gas-liquid Al/Cu hybrid heat exchanger 400 described above with respect to FIG. 4. Multi-layered gas-liquid Al/Cu hybrid heat exchanger 1100 may include fins 1104 configured similarly to fins 404 of FIG. 4. Multi-layered gas-liquid Al/Cu hybrid heat exchanger 1100 may further include a body 1102 configured similarly to body 402 of FIG. 4 with respect to flow of liquid and coupling to fins 1104.

Body 1102 may further include a plurality of layers 1108. The plurality of layers 1108 may each include alternating aluminum and copper layers. In alternate embodiments, the aluminum layers of the plurality of layers may be aluminum alloy and/or the copper layers of the plurality of layers may be copper alloy. Plurality of layers 1108 may extend in the x-z plane and may comprise a body of the gas-liquid Al/Cu hybrid heat exchanger (e.g., equivalent to body 402 of FIG. 4).

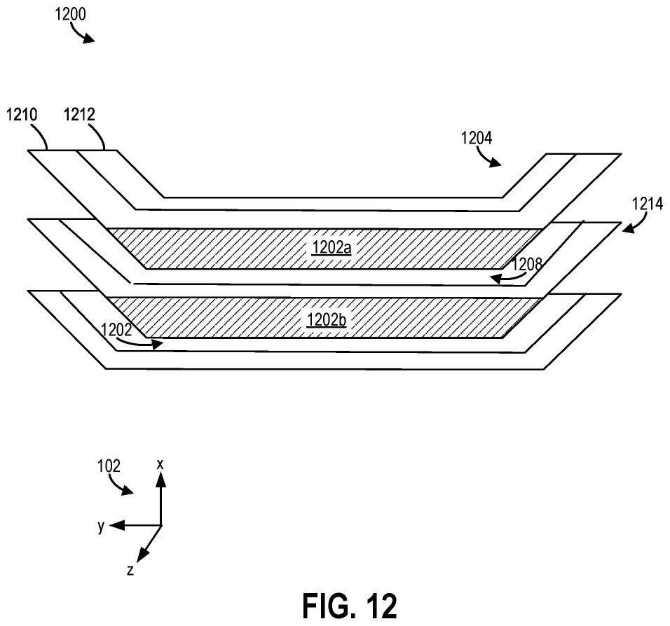

Turning now to FIG. 12, a section of a multi-layered multi-channel liquid-liquid Al/Cu hybrid heat exchanger 1200 is shown. Multi-layered multi-channel liquid-liquid Al/Cu hybrid heat exchanger 1200 may be similar to multi-channel liquid-liquid Al/Cu hybrid heat exchanger 500 described above with respect to FIG. 5. Multi-layered multi-channel liquid-liquid Al/Cu hybrid heat exchanger 1200 may include a plurality of fins 1202 formed of copper including a first fin 1202a and a second fin 1202b, coupled to a plurality of bodies 1204 (e.g., plurality of plates). A first fin 1202a may be positioned within a first liquid passage 1208 and second fin 1202b may be positioned within a second liquid passage 1214. A first liquid may flow through first liquid passage 1208 and a second liquid may flow through second liquid passage 1214. The plurality of bodies 1204 and fins 1202 may be stacked further in the x-direction thereby forming additional passages which may alternate between flowing the first fluid and the second fluid as described above with respect to FIG. 5.

Plurality of bodies 1204 may each be formed of at a first layer 1210 and a second layer 1212. A first side of first layer 1210 may be fixedly coupled to a fin of plurality of fins 1202. Second layer 1212 may be coupled to and completely cover a second side of first layer 1210, opposite the first side. First layer 1210 may be fixedly coupled to second layer 1212 by furnace brazing. In one example, first layer 1210 may be formed of copper and second layer 1212 may be formed of aluminum. In an alternate example, first layer 1210 may be formed of aluminum and second layer 1212 may be formed of copper. In further examples, the aluminum layer may be an aluminum alloy and/or the copper layer may be a copper alloy. In some examples, the plurality of bodies 1204 may include further layers stacked in addition to first layer 1210 and second layer 1212. For example, each of the plurality of bodies 1204 may be formed of 3 layers, 4 layers, or any additional number of layers.

In some examples, a multi-layered single sided Al/Cu hybrid heat exchanger such as the first example 900 described above with respect to FIG. 9A may be configured to cool a device, such as power modules in traction inverters for a vehicle, which may also demand electrical coupling to a copper surface. In such examples, a copper layer, such as copper layer 906 of FIG. 9A, may function as both a heat conductive portion of a cover of the multi-layered single sided Al/Cu hybrid heat exchanger and as an electrical coupling point. In this way, space and weight may be reduced with respect a heat exchanger that does not include a copper portion by not coupling an additional copper component to the heat exchanger for electrical coupling of the electronic component.

A side view of an example of a system 1300 including an electronic component 1314 and a third example of a multi-layered single sided liquid Al/Cu hybrid heat exchanger 1302 is shown in FIG. 13A. Third example 1302 may be similar to first example 900 described above with respect to FIG. 9A and may include a cover 1304 and a base 1306 defining a passage 1308 through which liquid coolant may flow.

A copper portion 1312 may be coupled to a hot side 1310 (similar to hot side 912) of cover 1304. Copper portion 1312 is not equivalent to a turbulizer (e.g., turbulizer 108 of FIG. 1A) because it is coupled to the hot side 1310 and does not contact the liquid coolant in passage 1308. In third example 1302, sides 1316 parallel to the z-axis and a first face 1318 of copper portion 1312 parallel to the x-axis may be in face sharing contact with cover 1304. In this way copper portion 1312 may be nested within cover 1304 and first face 1318 does not protrude past hot side 1310 of cover 1304. A depth along the z-axis of copper portion 1312 may be equal to or less than a depth along the z-axis of cover 1304. In third example 1302, copper portion 1312 does not protrude past (e.g., is flush with) cover 1304. In an alternate example, system 1300 may include a fourth example 1320 of a multi-layered single sided Al/Cu hybrid heat exchanger shown in a side view in FIG. 13B. As shown in fourth example 1320, copper portion 1312 may protrude a distance along z-axis past the hot side of cover 1304. In such examples, a depth along the z-axis of copper portion 1312 may be greater than the depth along the z-axis of cover 1304. In some examples, copper portion 1312 may not be nested in cover 1304 and a face of copper portion 1312 may be in face sharing contact with cover 1304, but sides parallel to the z-axis of copper portion 1312 may not be in contact with cover 1304.

Electronic component 1314 may be both thermally and electrically coupled to copper portion 1312. In some examples, electronic component 1314 may be soldered to copper portion 1312. In further examples a footprint of electrical component including a width 1315 along the x-axis and a length along the y-axis may be equivalent to a footprint of the copper portion 1312. Turning now to FIGS. 13C-13D, a view the footprint of copper portion 1312 is shown looking at hot side 1310 of cover 1304. Electronic component 1314 is omitted from the view of FIGS. 13C-13D for clarity. The footprint copper portion 1312 may include a width 1360, a length 1362, and a spacing 1364. In some examples, as shown in FIG. 13C, cover 1304 may be coupled to more than one copper portion 1312, each copper portion 1312 spaced apart by spacing 1364. In alternate examples, as shown in FIG. 13D, a single copper portion 1312 may be coupled to cover 1304. The footprint of copper portion 1312 may be at least as large as the footprint of electronic component 1314 and the footprint of electronic component 1314 may be positioned directly on top of and in face sharing contact with the footprint of copper portion 1312. In some examples, an area of the footprint of electronic component 1314 may be greater than the footprint of copper portion 1312. In still further examples, copper portion 1312 may comprise an entire outer surface of cover 1304 as described above with respect to copper layer 906 of FIG. 9A.

Turning now to FIG. 14, an example of a tube-fin heat exchanger which is an Al/Cu hybrid heat exchanger 1400 is shown. Tube-fin Al/Cu hybrid heat exchanger may include a tube shaped body 1402 through which a fluid may be flowed in the y-direction. In some examples a plurality of a plates 1404 may completely circumferentially surround tube shaped body 1402 in a radial direction (e.g., parallel to a plane defined by the x-axis and z-axis) and may be spaced along tube shaped body 1402 in the axial direction (e.g., along the y-axis). The plurality of plates 1404 may be configured to interact with a separate fluid to exchange heat. In some examples, the plurality of plates may instead be fins which partially circumferentially surround tube shaped body 1402.

Tube shaped body 1402 may be formed of aluminum. In some examples, at least one of the plurality of plates 1404 may be formed of copper. In alternate examples, the plurality of plates 1404 may be formed of alternating aluminum and copper plates. In further examples, each of the plurality of plates may be formed entirely of copper. In still further examples, plurality of plates 1404 may be bimetallic and formed of an alloy of copper and aluminum. In any of the above embodiments, the plurality of plates 1404 may be fixedly coupled tube shaped body 1402 by furnace brazing.

Turning now to FIG. 15, an example of a concentric tube heat exchanger which is an Al/Cu hybrid heat exchanger 1500 is shown. Concentric tube Al/Cu hybrid heat exchanger 1500 may include an outer tube (e.g., outer body) 1502 and an inner tube (e.g., inner body) 1504. An outer surface of inner tube 1504 may be circumferentially surrounded by an inner surface of outer tube, thereby forming a first passage 1506 between the outer surface of inner tube 1504 and the inner surface of outer tube 1502. A first fluid may flow through first passage 1506. A second passage 1510 may be defined by an inner surface of inner tube 1504 and a second fluid may flow through second passage 1510. Both inner tube 1504 and outer tube 1502 may be formed of aluminum.

Concentric tube Al/Cu hybrid heat exchanger 1500 may further include a plurality of fins 1508 extending radially between the outer surface of inner tube 1504 and the inner surface of outer tube 1502. In one example, at least one of the plurality of fins 1508 may be formed of copper. In an alternate each of the plurality of fins 1508 may be formed of copper. In further examples, each of the plurality fins 1508 may be bimetallic and formed of an alloy of copper and aluminum. In each of the above examples, the plurality of fins 1508 may be fixedly coupled between inner tube 1504 and outer tube 1502 by furnace brazing.

FIGS. 1A-15 show non-limiting embodiments of an Al/Cu hybrid heat exchanger. The Al/Cu hybrid heat exchanger may include any combination of aluminum and copper components or alloys thereof fixedly coupled to each other by furnace brazing. As non-limiting examples, the Al/Cu hybrid heat exchanger may include any combination of a copper or aluminum body, copper or aluminum cover, and optionally copper and/or aluminum turbulizers wherein at least one component (e.g., cover, body or turbulizer) is formed of copper and at least one component is formed of aluminum. Either the copper or aluminum component may optionally be a copper alloy or an aluminum alloy. Further, a heat transfer enhancement component, such dimples or ribs, may be formed into the body. Any of the embodiments of FIGS. 1A-15 may also include one or more additional coating layers. The additional coating layers may be comprised of elements such as Ni,

Sn. Zn, Ag, or other elements or alloys of elements deemed to be beneficial to the Al/Cu hybrid heat exchanger. For example, the one or more additional coatings may increase resistance to corrosion, increase part strength, and/or increase solderability of the Al/Cu hybrid heat exchanger.

The Al/Cu hybrid heat exchanger allows for cost savings by forming at least some of a body and cover of aluminum, but increases heat transfer efficiency by strategic placement of copper components such as fins and turbulizers. In this way, heat transfer efficiency can be increased in heat exchangers where 100% copper material may be undesirable due to either weight and/or cost of the material. The copper and aluminum components may be joined to form the Al/Cu hybrid exchanger by controlled atmosphere furnace brazing which is a continuous and scalable manufacturing process. Further, including a layer of copper on a hot side of a cover may provide an additional function of a conductive surface which may be soldered to an electronic component. The Al/Cu hybrid heat exchanger may be beneficial in both applications where heat needs to be transferred out of a component (e.g., cooled) and where heat needs to be transferred to a component (e.g., warmed). In such examples, the hot side of the cover may be colder than the cold side of the cover.

The disclosure also provides support for a heat exchanger, comprising: an aluminum or aluminum alloy component including a body and/or a cover, and a copper or copper alloy component fixedly coupled to the aluminum or aluminum alloy component, wherein the copper or copper alloy component is a heat transfer enhancement component. In a first example of the system, the copper or copper alloy component is furnace brazed to the aluminum or aluminum alloy component. In a second example of the system, optionally including the first example, the copper or copper alloy component is positioned to be in direct contact with a coolant of the heat exchanger. In a third example of the system, optionally including one or both of the first and second examples, the copper or copper alloy component is a fin and/or a turbulizer. In a fourth example of the system, optionally including one or more or each of the first through third examples, the body and the cover together define a passage through which liquid flows and into which the heat transfer enhancement component extends. In a fifth example of the system, optionally including one or more or each of the first through fourth examples, the heat transfer enhancement component is positioned based on a position of a heat generating component coupled to a hot side of the cover. In a sixth example of the system, optionally including one or more or each of the first through fifth examples, dimensions of the heat transfer enhancement component depend on dimensions of a heat generating component coupled to a hot side of the cover. In a seventh example of the system, optionally including one or more or each of the first through sixth examples, the heat exchanger is configured as a tube-fin heat exchanger or a concentric tube heat exchanger.

The disclosure also provides support for an aluminum/copper hybrid heat exchanger, comprising: a body and/or cover formed of aluminum or aluminum alloy, a first heat transfer enhancement component formed of aluminum or aluminum alloy and fixedly coupled to the body and/or cover, and a second heat transfer enhancement component formed of copper or copper alloy and fixedly coupled to the body and/or cover. In a first example of the system, the second heat transfer enhancement component is fixedly coupled to the body and/or cover in a position under a higher heat load than a position of the first heat transfer enhancement component. In a second example of the system, optionally including the first example, the aluminum/copper hybrid heat exchanger includes the body and the cover configured to together define a first coolant channel and a second coolant channel or a serpentine coolant channel. In a third example of the system, optionally including one or both of the first and second examples, the aluminum/copper hybrid heat exchanger is a gas-liquid aluminum/copper hybrid heat exchanger. In a fourth example of the system, optionally including one or more or each of the first through third examples, dimensions of the first heat transfer enhancement component are different than dimensions of the second heat transfer enhancement component. In a fifth example of the system, optionally including one or more or each of the first through fourth examples, an amount of the first heat transfer enhancement component is different than an amount of the second heat transfer enhancement component. In a sixth example of the system, optionally including one or more or each of the first through fifth examples, the aluminum/copper hybrid heat exchanger includes an aluminum or aluminum alloy layer and a copper or copper alloy layer fixedly coupled to the aluminum or aluminum alloy layer.

The disclosure also provides support for a system, comprising: an aluminum/copper (al/Cu) hybrid heat exchanger including: a cover formed of aluminum or aluminum alloy, wherein the cover includes a hot side positioned on an outer surface of the cover and a cold side coupled to a body of the al/Cu hybrid heat exchanger, a copper or copper alloy portion directly fixedly coupled to the hot side of the cover, and an electronic component, electrically coupled to the copper or copper alloy portion and configured to transfer heat to the al/Cu hybrid heat exchanger. In a first example of the system, a first face of the copper or copper alloy portion does not protrude past the hot side of the cover. In a second example of the system, optionally including the first example, the copper or copper alloy portion protrudes a distance past the hot side of the cover. In a third example of the system, optionally including one or both of the first and second examples, the copper or copper alloy portion includes more than one copper or copper alloy portion, each of the more than one copper or copper alloy portion electrically coupled to the electronic component.

The disclosure also provides support for a heat exchanger, comprising: a first component formed of aluminum or aluminum alloy, and a second component formed of copper or copper alloy, wherein the first component is brazed to the second component by a furnace braze process.

FIGS. 1A-15 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A heat exchanger, comprising:
an aluminum or aluminum alloy component including a body and/or a cover; and
a copper or copper alloy component fixedly coupled to the aluminum or aluminum alloy component, wherein the copper or copper alloy component is a heat transfer enhancement component.

2. The heat exchanger of claim 1, wherein the copper or copper alloy component is furnace brazed to the aluminum or aluminum alloy component.

3. The heat exchanger of claim 1, wherein the copper or copper alloy component is positioned to be in direct contact with a coolant of the heat exchanger.

4. The heat exchanger of claim 1, wherein the copper or copper alloy component is a fin and/or a turbulizer.

5. The heat exchanger of claim 1, wherein the body and the cover together define a passage through which liquid flows and into which the heat transfer enhancement component extends.

6. The heat exchanger of claim 1, wherein the heat transfer enhancement component is positioned based on a position of a heat generating component coupled to a hot side of the cover.

7. The heat exchanger of claim 1, wherein dimensions of the heat transfer enhancement component depend on dimensions of a heat generating component coupled to a hot side of the cover.

8. The heat exchanger of claim 1, wherein the heat exchanger is configured as a tube-fin heat exchanger or a concentric tube heat exchanger.

9. An aluminum/copper hybrid heat exchanger, comprising:
a body and/or cover formed of aluminum or aluminum alloy;
a first heat transfer enhancement component formed of aluminum or aluminum alloy and fixedly coupled to the body and/or cover; and
a second heat transfer enhancement component formed of copper or copper alloy and fixedly coupled to the body and/or cover.

10. The aluminum/copper hybrid heat exchanger of claim 9, wherein the second heat transfer enhancement component is fixedly coupled to the body and/or cover in a position under a higher heat load than a position of the first heat transfer enhancement component.

11. The aluminum/copper hybrid heat exchanger of claim 9, wherein the aluminum/copper hybrid heat exchanger includes the body and the cover configured to together define a first coolant channel and a second coolant channel or a serpentine coolant channel.

12. The aluminum/copper hybrid heat exchanger of claim 9, wherein the aluminum/copper hybrid heat exchanger is a gas-liquid aluminum/copper hybrid heat exchanger.

13. The aluminum/copper hybrid heat exchanger of claim 9, wherein dimensions of the first heat transfer enhancement component are different than dimensions of the second heat transfer enhancement component.

14. The aluminum/copper hybrid heat exchanger of claim 9, wherein an amount of the first heat transfer enhancement component is different than an amount of the second heat transfer enhancement component.

15. The aluminum/copper hybrid heat exchanger of claim 9, wherein the aluminum/copper hybrid heat exchanger includes an aluminum or aluminum alloy layer and a copper or copper alloy layer fixedly coupled to the aluminum or aluminum alloy layer.

16. A system, comprising:
an aluminum/copper (Al/Cu) hybrid heat exchanger including:
a cover formed of aluminum or aluminum alloy, wherein the cover includes a hot side positioned on an outer surface of the cover and a cold side coupled to a body of the Al/Cu hybrid heat exchanger;
a copper or copper alloy portion directly fixedly coupled to the hot side of the cover; and
an electronic component, electrically coupled to the copper or copper alloy portion and configured to transfer heat to the Al/Cu hybrid heat exchanger.

17. The system of claim 16, wherein a first face of the copper or copper alloy portion does not protrude past the hot side of the cover.

18. The system of claim 16, wherein the copper or copper alloy portion protrudes a distance past the hot side of the cover.

19. The system of claim 16, wherein the copper or copper alloy portion includes more than one copper or copper alloy portion, each of the more than one copper or copper alloy portion electrically coupled to the electronic component.

20. A heat exchanger, comprising:
a first component formed of aluminum or aluminum alloy; and
a second component formed of copper or copper alloy,
wherein the first component is brazed to the second component by a furnace braze process.
